(19) United States
(12) Patent Application Publication
(10) Pub. No.: US 2024/0364109 A1
(43) Pub. Date: Oct. 31, 2024

(54) METHOD AND APPARATUS FOR RECORDING ENERGY GENERATION WITHIN AN ELECTRIC GRID VIA BLOCKCHAINS

(71) Applicant: JBB Advanced Technologies, LLC, Carrollton, TX (US)

(72) Inventors: John Taylor Billingsley, JR., Dallas, TX (US); Ronald Lyle Chichester, Waller, TX (US); Jason Alexander Novack, Frisco, TX (US)

(73) Assignee: JBB Advanced Technologies, LLC, DALLAS, TX (US)

(21) Appl. No.: 18/610,289

(22) Filed: Mar. 20, 2024

Related U.S. Application Data
(60) Provisional application No. 63/462,253, filed on Apr. 27, 2023.

(51) Int. Cl. H02J 3/00; H02J 3/38; H04L 67/104; H04L 67/1097

(52) U.S. Cl. CPC H02J 3/004; H02J 3/003; H02J 3/381; H04L 67/104; H04L 67/1097; H02J 2300/24; H02J 2300/28

(57) ABSTRACT

An energy monitoring device is disclosed. The monitoring device includes a network communication module, a date-time module, an electric power measurement module, a memory module, and a transaction construction module. The network communication module allows the energy monitoring device to communicate with another device on a peer-to-peer network. The date-time module keeps track of local date/time information. The electric power measurement module measures an amount of electric power produced/consumed by a power-generating/power-consuming entity. The transaction construction module constructs a blockchain transaction that incorporates the unique cryptographic identifier, the local date/time information, and the measured amount of electric power produced/consumed, and then places the blockchain transaction onto the 2peer-to-peer network for verification by a one or more nodes that comprises a blockchain.

### PRIORITY CLAIM

The present patent application claims priority under 35 U.S.C. § 119(e)(1) to provisional application No. 63/462,253 filed on Apr. 27, 2023, the contents of which are incorporated herein by reference.

### TECHNICAL FIELD

The present invention relates to distributed energy production within an electric power grid in general, and in particular to a method and apparatus for recording energy generation and consumption within an electric power grid by using blockchains.

### BACKGROUND

In 1882, Thomas Edison turned on the generators at the Pearl Street station in Lower Manhattan, which served 1,400 lamps. This set the stage for more power stations and, ultimately, led to today's integrated electric power grid. Moving forward 120 years, the proliferation of low-cost solar panels and wind turbines has renewed the debate regarding decentralized power generation versus centralized power generation. However, such debate is a false dichotomy because there is no single power source on the modern electric power grid. For example, within a power generating system, there are numerous individual power-generating stations, each with its own characteristics and capabilities. All of those power-generating stations are joined together seamlessly into an electric power grid.

In order for a power-generating source to be added to an existing electric power grid, a set of defining characteristics and capabilities must be met by the power-generating source. It has long been argued that renewable power-generating sources, such as solar panels and wind turbines, tend to lack certain characteristics and/or capabilities that allow them to be added to existing electric power grids. For example, weather-related issues such as clouds, rain, etc. and darkness can affect the performances of solar panels. Similarly, not enough wind or too much wind can degrade the performances of wind turbines significantly. Basically, the intermittency of power generation makes solar panels and wind turbines less reliable as power-generating resources, and such intermittency complicates their integration into an existing electric power grid.

The present disclosure provides an improved method and apparatus for recording the electric energy generation within an electric power grid having solar panels and wind turbines, which should make these distributed power sources more of a viable power-generating stations for an electric power grid.

### SUMMARY

In accordance with one embodiment of the present invention, an energy monitoring device on a power network includes a network communication module, a date-time module, an electric power measurement module, a memory module, and a transaction construction module. The network communication module allows the energy monitoring device to communicate with another device on a peer-to-peer network. The date-time module keeps track of local date/time information. The electric power measurement module measures an amount of electric power produced by a power-generating entity. The electric power measurement module can also measure an amount of electric power consumed by a power-consuming entity. The measured amount of electric power produced can be stored in the memory module that also stores a unique cryptographic identifier. The transaction construction module constructs a blockchain transaction that incorporates the unique cryptographic identifier, the local date/time information, and the measured amount of electric power produced/consumed, and then places the blockchain transaction onto the peer-to-peer network for verification by a blockchain, wherein a combination of the unique cryptographic identifier, the local date/time information, and the measured electric power produced/consumed is considered as a proof-of-power for the blockchain.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of an electric power grid in which an embodiment of the present invention can be incorporated;

FIG. 2 is a block diagram of a set of monitoring devices (M-devices) deployed within electric power grid from FIG. 1, according to one embodiment;

FIG. 3 is a block diagram of an M-device connected to a set of solar panels to record power generation, according to one embodiment;

FIG. 4 is a detailed block diagram of an M-device from FIG. 2, according to one embodiment; and

FIG. 5 is a block diagram of a transaction for an energy blockchain, according to one embodiment.

### DETAILED DESCRIPTION OF A PREFERRED EMBODIMENT

### Blockchain

A blockchain is a decentralized record of transactions that is constantly being reviewed and updated. Virtually any asset can be tracked by a blockchain network, even though the blockchain technology is commonly associated with cryptocurrencies such as Bitcoin and Ethereum, each having its own associated blockchain network.

A block is a collection of data that contains a timestamp and other encrypted information about one or more transactions. A transaction can be, for example, a sender sending some Bitcoins to a receiver. A block for one or more transactions is then sent to a peer-to-peer network of computers known as nodes in which the one or more transactions will be validated. There may be thousands of nodes around the world simultaneously vying to verify the transaction using consensus algorithms, and this process is called mining.

There are different consensus algorithms for verifying transactions. In cryptocurrency, the most common methods are proof-of-work and proof-of-stake. A miner who first successfully completes the validation of a new block will be rewarded with, typically, a combination of newly minted Bitcoins (for proof-of-work) or Ethereum (for proof-of-stack) and transaction fees, which are then passed on to the sender and the receiver.

A new block can be added to the existing blockchain using a set of alphanumeric strings known as hashes. Serving as a digital footprint, a hash confirms a transaction on a blockchain. Similarly, a second hash can verify the block, and a third hash can verify a set of blocks (or the entire blockchain). After the update has been distributed across the nodes within the peer-to-peer network, the transaction is complete, and the blockchain is considered immutable. No single party can change a transaction after it has been added to the blockchain.

### Electric Power Grid

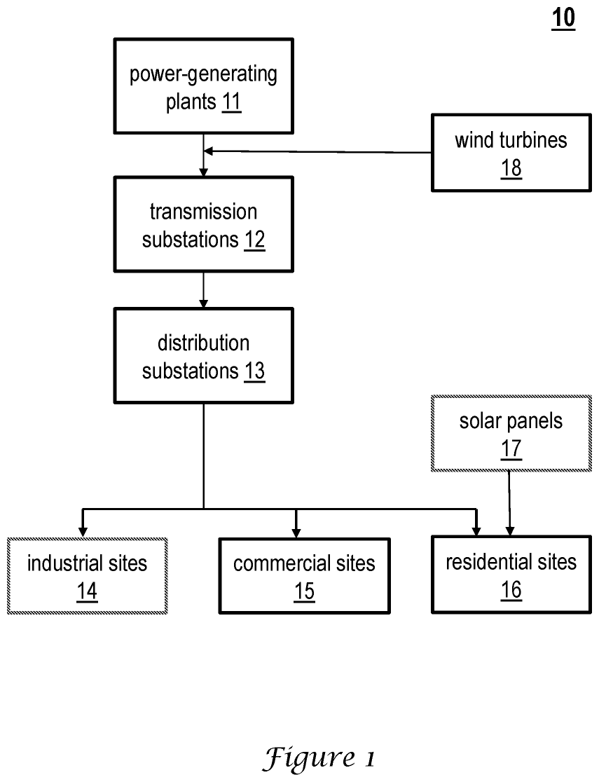

Referring now to the drawings and in particular to FIG. 1, there is illustrated a block diagram of an electric power grid in which an embodiment of the present invention can be incorporated. An electric power grid 10 typically includes one or more Independent System Operators (ISOs) and Regional Transmission Organizations (RTOs). ISOs and RTOs have the responsibility for generating and delivering power to customers within their respective jurisdictions of the national electric grid. While the infrastructure of each ISO and RTO is unique to its jurisdiction because of geography, demographics, etc., each ISO and RTO typically has one or more power-generating plants 11, which transmit the generated power to one or more transmission substations 12. Transmission substations 12 deliver the power received to one or more distribution substations 13. Distribution substations 13 then ensure that their allocation of power is delivered to, for example, industrial sites 14, commercial sites 15 and/or residential sites 16.

In addition, electric power grid 10 may include distributed power-generating stations such as solar panels and wind turbines. For example, wind turbines 18 may be connected to the power lines coming out of power-generating plants 11. Some of residential sites 16 may have a set of solar panels 17 installed on roof tops to provide electricity to those residential sites. Solar panels 17 and wind turbines 18 are considered as renewable energy sources that are supposed to be more environmentally friendly than power-generating plants 11 that burn fossil fuels.

The coordination among power-generating plants 11, transmission substations 12, and distribution substations 13 can be enabled by private telecommunications networks such as microwave network that transmits signals wirelessly. Power-generating plants 11, transmission substations 12, and distribution substations 13 can also communicate with each other via a public communication network, such as the Internet, using cables.

### Monitoring Devices

Typically, each end-consumer of power, such as industrial sites 14, commercial sites 15, and residential sites 16, already includes a power meter to record the amount of power consumption.

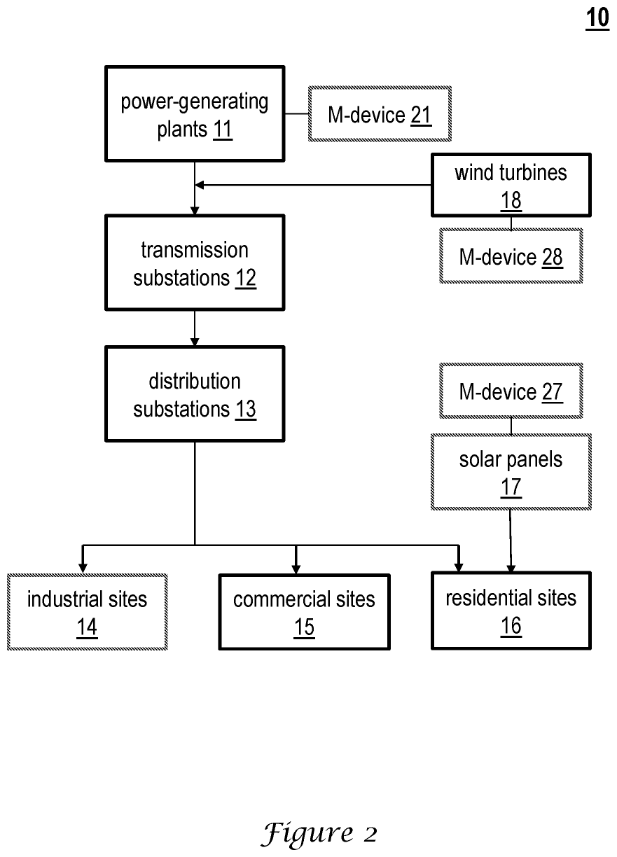

In accordance with one embodiment of the present invention, a set of monitoring devices (M-devices) is added to various power generating entities within an electric power grid for monitoring and recording the amount of power generation and power consumption. With reference now to FIG. 2, there is depicted a block diagram of a set of M-devices deployed within electric power grid 10 to monitor power generation of certain power-generating entities, according to one embodiment. As shown, distributed power-generating stations, such as solar panels 17 and wind turbines 18, which are not owned or operated by the above-mentioned ISO/RTO organizations are fitted with their own respective M-devices. For example, each of solar panels 17 is fitted with a corresponding M-device 27, and each of wind turbines 18 is fitted with a corresponding M-device 28. M-devices 27 and 28 are utilized to measure the amount of electric power generated by solar panels 17 and wind turbines 18, respectively. Similarly, each of power-generating plants 11 is fitted with a corresponding M-device 21. M-device 21 is utilized to measure the amount of electric power generated by power-generating plants 11.

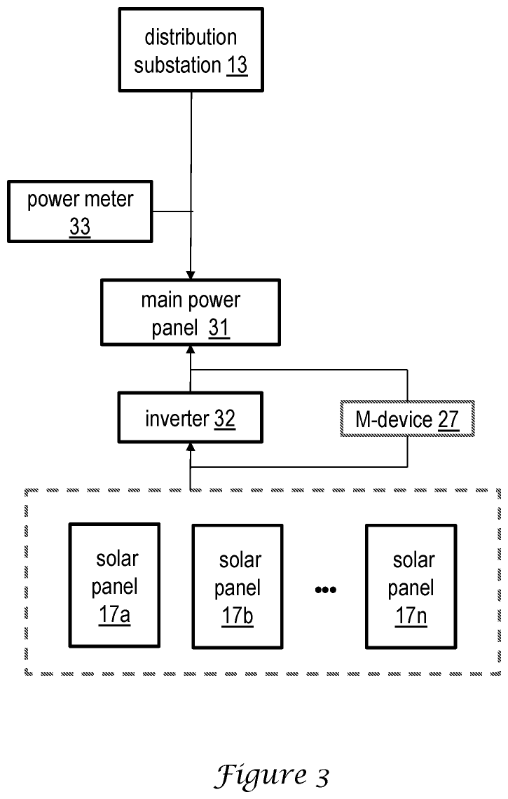

Referring now to FIG. 3, there is illustrated a block diagram of M-device 27 connected to solar panels 17 to record power generation, according to one embodiment. As shown, a main power panel 31 of a residential site (such as residential sites 16 in FIG. 2) receives electric power from local distribution substation 13, and the amount of electric power received is recorded by a power meter 33. In addition, main power panel 31 of the residential site also receives electric power from a set of photovoltaic solar panels 17a-17n via an inverter 32 that converts direct current (DC) to alternating current (AC). Here, solar panels 17a-17n represent one of many distributed power-generating stations within an electric power grid. M-device 27 monitors the amount of electric power produced by solar panels 17a-17n before and after AC conversion at any given time.

The structure and functionalities of M-devices 21 and 27-28 are substantially identical to each other. Thus, only M-device 27 is further described in details.

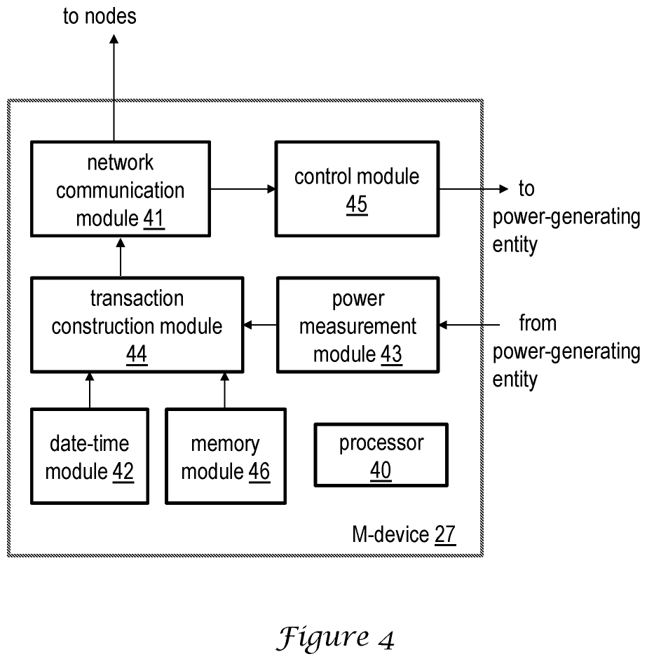

With reference now to FIG. 4, there is illustrated a detailed block diagram of M-device 27, according to one embodiment. As shown, M-device 27 includes a processor 40, a network communication module 41, a date-time module 42, an electric power measurement module 43, a transaction construction module 44, a control module 45, and a memory module 46. Network communication module 41 allows M-device 27 to communicate with another device and/or node on a peer-to-peer network via wire and/or wirelessly. Network communication module 41 can be, for example, a network interface card. Date-time module 42 keeps track of local date/time information in real-time.

Electric power measurement module 43 measures the amount of electric power produced by a power-generating entity. The power-generating entity can be a conventional power-generating plant (such as power-generating plants 11 in FIG. 2) or a distributed power-generating station (such as solar panels 17 and wind turbines 18 in FIG. 2). When power generation has been detected, electric power measurement module 43 measures and then records the amount of power generated in memory module 46. Electric power measurement module 43 can also measure the amount of electric power consumed by a power-consuming entity.

Memory module 46 is also utilized to store a unique cryptographic identifier, which can be a public key or a public/private key pair. The only requirement for the unique cryptographic identifier is that it has to be unique for all the M-devices and nodes within all of the electric power grids. Memory module 46 can be, for example, an EEPROM (manufactured by Microchip Technologies Inc. of Chandler, Arizona).

In addition to monitoring power generation, M-device 27 can also be utilized to turn on and off power generation activity of a power-generating entity being monitored via a power ON/OFF signal. The power ON/OFF signal can be sent to M-device 27 remotely. After receiving a power OFF signal, network communication module 41 sends the power OFF signal to control module 45, which then shuts off the power-generation activity of the power-generating entity being monitored. Conversely, after receiving a power ON signal, network communication module 31 sends the power ON signal to control module 55, which then turns on the power-generation activity of the power-generating entity being monitored.

M-device 27 is provided with enough computing capacity via processor 40 to operate as a node for a blockchain, and thus transactions signifying power generation can be posted via an Application Programming Interface (API) on a local node of the blockchain for propagation according to a consensus algorithm for the blockchain.

Optionally, other power-generating entities, such as power-generating plants 11 in FIG. 2, may also post blockchain transactions via its associated M-device 21 in order to record performance. Also, power-consuming entities can post blockchain transactions via its associated M-device in order to record performance.

Transaction construction module 44 can construct a blockchain transaction that incorporates an unique cryptographic identifier (from memory module 46), date-time information (from date-time module 42), and the amount of power produced/consumed (from memory module 46).

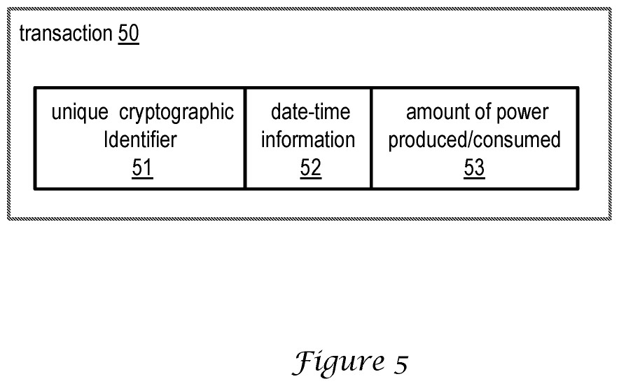

Referring now to FIG. 5, there is depicted a block diagram of a transaction for an energy blockchain, according to one embodiment. As shown, a blockchain transaction 50 includes an unique cryptographic identifier 51, date-time information 52, and the amount of power produced/consumed 53. Blockchain transaction 50 can be placed on a peer-to-peer network (via network communication module 41) to be accepted by a custom blockchain, such as an “energy blockchain” for the present embodiment. If the transaction is accepted by the energy blockchain, then the transaction will be recorded by all nodes that are connected to the peer-to-peer network of the energy blockchain, thus forming a “proof-of-power” consensus algorithm employed by all the nodes of the energy blockchain. In this example, the peer-to-peer protocol of the energy blockchain accepts a unique HIPv2 cryptographic identifier, date/time information along with the recorded value of power generated as the “proof-of-power.” In other words, for the purpose of verification, the proof-of-power is considered as equivalent to proof-of-work or proof-of-stake in other conventional blockchains.

The proof-of-power consensus algorithm has many advantages over the other conventional blockchains. First, proof-of-power requires relatively little computational power for verification of the identity of an underlying M-device that posted the transaction. This means that more transactions can be processed per second, which is essential, given the scale of the number of M-devices that are connected to the nation's electric power grid. Second, by not requiring contemporaneous trading of power between generators and consumers, the present invention can accommodate interruptions due to natural disasters because the transactions can be stored locally, and then transmitted after network connectivity is restored. Settlement of costs and rewards can be handled post facto with something as simple as a block explorer because each transaction has been immutably recorded on an energy blockchain, independent of the time that the transaction was recorded on the energy blockchain.

Energy blockchains have two or more nodes that are connected via a peer-to-peer network. The nodes receive blockchain transactions via the peer-to-peer network that operates within a ISO/RTO hierarchy. Those transactions will be verified using a consensus algorithm among the various nodes making up the energy blockchain. The verified transactions are accumulated into a block, and when the block is full, it is incorporated (cryptographically) into the chain of blocks that forms the energy blockchain. Some energy blockchains are public, meaning that anyone can connect an M-device to the peer-to-peer network to post transactions on the nodes. Some energy blockchains are private, meaning that only authorized M-devices are allowed to post transactions with the nodes. The M-device of the present invention can utilize a public and/or private blockchain. The choice of energy blockchain design depends on the perceived and real balance of pros and cons for the organizations that operate an electric power grid.

Periodically (or as a function of the amount of power generated regardless of the time period required for such generation), an M-device can generate and post a blockchain transaction onto a peer-to-peer network for recording on the blockchain. The selection and placement of M-devices can vary substantially, depending upon the available bandwidth for the peer-to-peer network, power availability, and how the distributed power generation are connected to the electric power grid.

Before deployment into an electric power grid, the authenticity of each M-device needs to be verified by a certification authority. Specifically, one or more authorities will certify the unique cryptographic identifier of an M-device. For example, the certifying authority can publish a Table of Accepted Internet Protocol addresses, public keys, HIPv2 keys, etc. that uniquely identify an M-device, thereby certifying the authenticity of the M-device and the transaction information produced by that M-device. By providing a certified Table of Accepted M-device unique identifiers, the mining operation for the blockchain is greatly simplified, and thus the certification of the energy-related transactions can be accomplished much faster and with far less energy than conventional blockchains.

The preferred embodiment of the present invention includes the ability to power-on and/or power-off the energy-producing/energy-consuming subsystems on an electric power grid. Such a capability enhances the resilience of the electric power grid because a central authority can restore operation to selected parts of the electric power grid in case of natural or man-made disasters. Similarly, by selectively switching on or off particular energy-producing and energy-consuming subsystems, limited power that is available from distributed energy resources can be diverted to critical energy-consuming subsystems (e.g., hospitals, clinics, or first-responders facilities) even when the larger energy-producing elements of the power grid are not available. In short, the present invention allows an electric power grid having distributed energy-generating stations to continue operations even if portions of the electric power grid have been impaired. This is accomplished by containing and isolating the problem areas while enabling operations in other areas.

As has been described, the present invention provides a method and apparatus for reporting energy generation/consumption within an electric power grid by using energy blockchains.

While the invention has been particularly shown and described with reference to a preferred embodiment, it will be understood by those skilled in the art that various changes in form and detail may be made therein without departing from the spirit and scope of the invention.

What is claimed is:

1. An energy monitoring device comprising:
a network communication module for communicating with another device on a peer-to-peer network;
a date-time module keeps track of local date/time information;
an electric power measurement module measures and records an amount of electric power produced by a power-generating entity;
a memory module for storing a unique cryptographic identifier and said measured electric power produced; and
a transaction construction module constructs a blockchain transaction by combining said unique cryptographic identifier, said local date/time information, and said measured electric power produced, and then places said blockchain transaction onto said peer-to-peer network for verification by an energy blockchain, wherein a combination of said unique cryptographic identifier, said local date/time information, and said measured electric power produced is considered as a proof-of-power for said energy blockchain.

2. The monitoring device of claim 1, wherein said unique cryptographic key is a public key.

3. The monitoring device of claim 1, wherein said unique cryptographic key is a public/private key pair.

4. The monitoring device of claim 1, wherein said network communication module is associated with a unique protocol address.

5. The monitoring device of claim 1, wherein said network communication module is a network interface card.

6. The monitoring device of claim 1, wherein said memory module is a programmable memory.

7. The monitoring device of claim 1, wherein said programmable memory is an EEPROM.

8. The monitoring device of claim 1, wherein said electric power measurement module measures an amount of electric power consumed by a power-consuming entity.

9. The monitoring device of claim 8, wherein said measured electric power consumed is stored in said memory module.

10. The monitoring device of claim 9, wherein said transaction construction module constructs a blockchain transaction by combining said unique cryptographic identifier, said local date/time information, and said measured electric power consumed.

11. The monitoring device of claim 1, wherein said monitoring device further includes a control module to control said power-generating entity by
turning on said power-generating entity in response to a receipt of an ON signal from said network communication module; and
turning off said power-generating entity in response to a receipt of an OFF signal from said network communication module.

12. The monitoring device of claim 1, wherein said monitoring device utilizes a modified TCP/IP protocol that includes an HIPv2 identifier, wherein said HIPv2 identifier lies between an Internet Protocol layer and a transport layer of a TCP/IP protocol stack.

13. The monitoring device of claim 1, wherein an authenticity of said monitoring device is certified by a certification authority by verifying said unique cryptographic identifier uniquely identifies said monitoring device.

14. The monitoring device of claim 1, wherein said monitoring device includes a processor.

15. The monitoring device of claim 1, wherein said transaction construction module further constructs a second blockchain transaction by combining said unique cryptographic identifier, said local date/time information, and said measured electric power consumed.
